(19) United States
(12) Patent Application Publication
(10) Pub. No.: US 2010/0095936 A1
(43) Pub. Date: Apr. 22, 2010

(54) METHOD AND CONTROL DEVICE FOR CONTROLLING A FUEL INJECTOR

(76) Inventor: Stefan SCHEMPP, Wernau (DE)

Correspondence Address: KENYON & KENYON LLP, ONE BROADWAY, NEW YORK, NY, 10004, US

(21) Appl. No.: 12/579,064

(22) Filed: Oct. 14, 2009

(30) Foreign Application Priority Data
Oct. 21, 2008 (DE) 102008042981.3

(51) Int. Cl. F02M 51/00

(52) U.S. Cl. 123/478

(57) ABSTRACT

A method for controlling a fuel injector, having a piezoelectric actuator, for an internal combustion engine. The method includes a step of controlling the actuator using an actuator current signal for a fuel injection, an actual actuator voltage being ascertained during the fuel injection. After a comparison of whether the actual actuator voltage is greater than an actuator voltage threshold value, if the actual actuator voltage is greater than the actuator voltage threshold value, the actuator current signal is controlled for an additional fuel injection, in such a way that the actual actuator voltage approaches a setpoint actuator voltage, during the additional fuel injection. Also a computer program product for carrying out the method, and a control device for controlling a piezoelectric actuator of a fuel injector for an internal combustion engine are also provided.

### CROSS-REFERENCE

This application claims the benefit under 35 U.S.C. §119 of German Patent Application No. DE 102008042981.3 filed on Oct. 21, 2008, which is expressly incorporated herein by reference in its entirety.

### FIELD OF THE INVENTION

The present invention relates to a method and a control device for controlling a fuel injector, particularly a fuel injector for an internal combustion engine which has a piezoelectric actuator. Furthermore, the present invention relates to a computer program product for implementing the method.

### BACKGROUND INFORMATION

Modern internal combustion engines often have fuel injectors, which have electrical control signals applied to them by suitable control devices, in order to inject fuel in a desired quantity into the combustion chamber or into the intake manifold of the internal combustion engine. The conversion of the electrical energy of the control signals into mechanical work takes place, for example, by piezoelectric actuators within the fuel injectors, which have one or more piezoelectric crystals situated between control electrodes.

When electric current of a control signal, having a current profile over time that is specifiable by a control device, is conducted to the control electrodes of the actuator, in order to execute a fuel injection using such a fuel injector, an electric voltage builds up between the control electrodes, whose curve over time is influenced both by the current profile over time and the electric capacitance of the actuator, and generally determines the quantity of the injected fuel and the quantity profile over time of the fuel injection. Therefore, in order to compensate for control device tolerances and actuator tolerances, among other things, based on manufacturing variances, controllers are used which adjust, for example, the actuator setpoint voltage at a certain point in time, during the fuel injection, by changing the control current signal.

In the operation of an internal combustion engine having several fuel injectors, which are assigned, for instance, to different cylinders of the internal combustion engine, one has to reckon with cases of interference, however, in which control electrodes of different fuel injectors are short circuited with one another unintentionally, for instance, by the effect of moisture, heat and/or mechanical damage in the region of connecting lines between the control device emitting the control signal and the piezoelectric actuators. In the case of a short circuit between two or more actuators, in which the latter are connected in parallel, the capacitances of the actuators add, so that, at a given current profile of the control signal, a correspondingly reduced actuator voltage builds up for one of the short circuited actuators. Now, if a control takes action, as described above, which raises the current profile of the control pulses for subsequent fuel injections in such a way that the voltage built up at the actuators reaches the actuator setpoint voltage, the short circuited actuators open simultaneously, so that, in different cylinders of the internal combustion engine, fuel is possibly injected simultaneously, and the operation of the internal combustion engine is considerably impaired.

For this reason, there exists a need to make possible the control of control signals for the compensation of a wide range of control device tolerances and actuator tolerances in which, at the same time, impairment of the operation of the internal combustion engine is avoided in the case of short circuits.

### SUMMARY

In view of this, an example method is provided for controlling a fuel injector for an internal combustion engine, which has a piezoelectric actuator. The example method includes a step of controlling the actuator using an actuator current signal for a fuel injection, an actual actuator voltage being ascertained during the fuel injection. After a comparison of whether the actual actuator voltage is above an actuator voltage threshold value, if the actual actuator voltage is greater than the actuator voltage threshold value, the actuator current signal is controlled for an additional fuel injection in such a way that the actual actuator voltage approaches a setpoint actuator voltage, during the additional fuel injection.

The example method according to the present invention makes possible selecting the actuator voltage threshold value in such a way that it is only slightly greater than the actual actuator voltage for which, when taking into account control device tolerances and actuator tolerances based on manufacturing variances, the influence of the temperatures at the control device and the actuator, etc., are expected to be a maximum for the case in which two actuators are connected in parallel. Since, even for the parallel connection of only two actuators, the actual actuator voltage to be expected at a given control current signal falls off considerably (e.g., to about one-half at an approximately double actuator capacitance) and, for the parallel connection of more than two actuators, an even greater drop of the actual actuator voltage is to be expected, a broad range of control device tolerances and actuator tolerances is able to be compensated for, so that a cost-effective design of the control devices and the actuators is made possible having correspondingly great tolerances.

Among additional points, a computer program product for executing the method and a control device for controlling a fuel injector, for an internal combustion engine, are provided, the fuel injector having a piezoelectric actuator. The control device includes a control unit which controls the actuator using a control current signal for a fuel injection, a voltage meter which ascertains an actual actuator voltage during the fuel injection, a voltage comparator which ascertains whether the actual actuator voltage is above the actuator voltage threshold value, and a control current controller which, if the actual actuator voltage is above the actuator voltage threshold value, controls the control current signal for an additional fuel injection in such a way that the actual actuator voltage approaches a setpoint actuator voltage during the additional fuel injection.

According to one preferred refinement of the example method according to the present invention, a further step is provided for ascertaining a temperature at the actuator and a step for ascertaining the actuator voltage threshold value based on the temperature. The actuator capacitance of piezoelectric actuators is generally temperature-dependent, which directly influences the magnitude of the actual actuator voltage that is ascertainable at the actuator in response to a given control current signal. The change in the capacitance of an actuator with its temperature is additionally also effective if the actuator is connected in parallel to an additional actuator when there is a short circuit, since, in that case, the capacitances of the actuators are additive. Consequently, the capacitance of the actuator in interference-free operation, and the capacitance of the actuators connected in parallel in the interference case, demonstrate a dependence on the temperature that is in the same direction. Furthermore, also for a given control current signal, the actual actuator voltage at the actuator in interference-free operation and the actual actuator voltage at the actuator connected in parallel, in the interference case, demonstrate an equidirectional dependence on the temperature.

Ascertaining the actuator voltage threshold value as a function of the temperature at the actuator therefore makes possible selecting the actuator voltage threshold value as a function of temperature in such a way that its temperature dependence is in the same direction as the temperature dependence of the actual actuator voltage at the actuator in interference-free operation for a given control current signal. This makes possible compensating a still further range of control device tolerances and actuator tolerances, so that an even more cost-effective design is made possible for the control devices and the actuators at correspondingly greater tolerances.

The ascertaining of the temperature at the actuator preferably takes place based on a fuel temperature or/and a cooling water temperature of the internal combustion engine. This is possible cost-effectively since, as a rule, temperature sensors are already present for the fuel temperature or the cooling water temperature, and the actuators typically have the cooling water circulation and/or the fuel supply flowing around them, and are therefore influenced by their temperatures.

According to one preferred refinement, the ascertainment of the actuator voltage threshold value further takes place based on at least one characteristics variable of the fuel injector. By doing this, one may advantageously take into consideration the manufacturing variances of the fuel injectors, so that it becomes possible to compensate for an even broader range of control device tolerances and actuator tolerances.

According to one preferred refinement, ascertaining the actuator voltage threshold value includes a linear interpolation between a first and a second supporting value. A calculation of this type requires particularly little computing capacity and low energy consumption in the control device. The first and the second supporting values preferably correspond to a minimum or maximum operating temperature of the actuator, so that inaccuracies connected with extrapolations may be avoided.

According to another preferred refinement, a further step is provided for ascertaining the setpoint actuator voltage, based on the pressure in a fuel pressure accumulator of the internal combustion engine and/or at least a characteristics variable of the fuel injector. In this way, the setpoint actuator voltage is able to be adjusted precisely to an individual fuel injector and the operating conditions.

According to still another preferred refinement, a further step is provided for emitting a fault signal if the actual actuator voltage is not greater than the actuator voltage threshold value. The fault signal makes it possible, for instance, to store diagnostic data that may be called up by service personnel, to emit a warning signal to the driver or to initiate the emergency shutting down of the internal combustion engine.

### BRIEF DESCRIPTION OF THE DRAWINGS

The present invention is explained below with reference to preferred specific embodiments and the figures.

FIG. 1 shows a diagram of a voltage curve at an actuator of a fuel injector.

FIG. 2 shows a block diagram of a control device for controlling a fuel injector, according to one specific embodiment.

FIG. 3 shows a state diagram of the connection between the electrical actuator capacitance and the electric voltage present at the actuator.

FIG. 4 shows a flow chart of a method for controlling a fuel injector, according to one specific embodiment.

### DETAILED DESCRIPTION OF EXAMPLE EMBODIMENTS

In the figures, like or functionally equivalent components are denoted by like reference numerals, provided that nothing is indicated to the contrary.

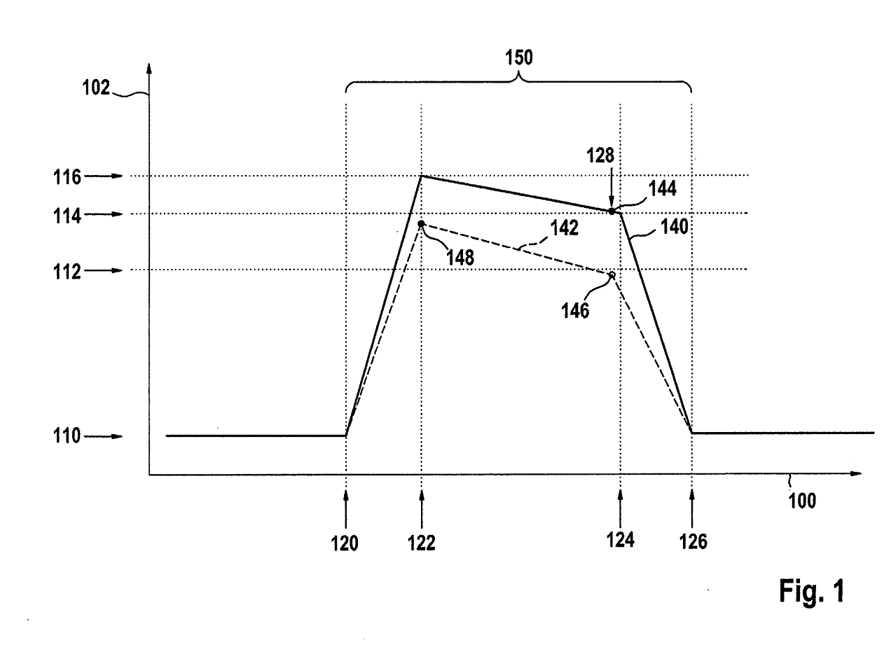

FIG. 1 shows a curve diagram generated by an horizontal time axis 100 and a vertical voltage axis 102, in which two curves 140, 142 are shown. The first curve 140 of the two curves 140, 142 shows a typical voltage curve over time on a piezoactuator of a fuel injector, which sets in in interference-free operation when the actuator is activated to execute a fuel injection 150 by a control device, using a control signal having a certain current curve over time that is not shown. The second curve 142, the dashed line of the two curves 140, 142, reflects a voltage curve over time that sets in at the same actuator during actuation using the same current curve over time, in a case when the actuator is connected in parallel with an additional actuator, for instance, based on a short circuit of connecting lines or some other type of interference. The fact that both voltage curves 140, 142 are plotted against the common time axis 100 does not mean that voltage curves 140, 142 run at the same time, but rather that both voltage curves 140, 142 are based on a control current signal that runs identically with respect to time axis 100.

According to first voltage curve 140, which renders the interference-free operation, a voltage 110 of 0 V is first present at the actuator, which remains constant up to a charging initiation time 120. At charging initiation 120, a charging current pulse of the control signal is switched on, which increases voltage 140 present at the actuator corresponding to the electrical capacitance of the actuator. At a charging end time 122, at which the charging current pulse ends, voltage 140, that is present at the actuator, reaches a maximum value 116. Voltage 140 now drops off gently, until, at a discharge initiation time 124, a discharge current pulse of the control signal is switched on, which has a polarity that is opposite to the charging current pulse, and which lowers again voltage 140, that is present at the actuator, until, at discharge end time 126, initial voltage 110 of 0 V is reached again.

According to second voltage curve 142, which represents the operation in the interference case mentioned, voltage 110 of 0 V is also constantly present at the actuator, up to charging initiation time 120. At charging initiation 120, the charging current pulse of the control signal is switched on, which increases voltage 140 that is present at the actuator, corresponding to the electrical overall capacitance of the actuator and of the actuator connected in parallel to the actuator because of the interference. Since the overall capacitance of the actuator and of the additional actuator increases compared to the capacitance of the actuator, that is to be activated in the interference-free operation alone, but the control current pulse is assumed to be unchanged, second voltage curve 142 demonstrates a lesser increase after charging initiation 120 than the first voltage curve, and, at charging end time 122, it reaches a lesser maximum value 148, compared to maximum value 116 of first voltage curve 140. Analogously to first voltage curve 140, voltage 142 now drops off gently until, at discharge initiation time 124, the discharge current pulse of the control signal is switched on, by which, up to discharge end time 126, initial voltage 110 of 0 V is reached again.

In the interference-free operation, in order to ensure a desired injection quantity profile of subsequent fuel injections, at a certain measuring time 128 during fuel injection 150, which is in this case assumed to be shortly before discharge initiation 124, voltage 140, that is present at the actuator, is measured, in order to ascertain an actual actuator voltage 144, in this manner. A controller provided in the control device compares ascertained actual actuator voltage 144 to a setpoint actuator voltage 114, of which it is desired that it is to be reached in response to a subsequent fuel injection at measuring time 128 this subsequent fuel injection, and changes, for use for the subsequent fuel injection, the control signal used at the present fuel injection 150, in such a way that, for the voltage curve at the actuator during the subsequent fuel injection, the value to be measured of the actual actuator voltage at the measuring time reaches setpoint actuator voltage 114, or at least approaches setpoint actuator voltage 114.

If the abovementioned interference case of a short circuit between two actuators takes place, then at measuring time 128, an actual actuator voltage 146 is measured, that is reduced compared to the interference-free operation. In this case, in order to avoid that the controller of the control device increases the control current signal, that is to be used for the subsequent fuel injection, in such a way that, in spite of the actuator capacitance increased by the short circuit, the value to be measured during the subsequent fuel injection at the measuring time, of the actual actuator voltage reaches setpoint actuator voltage 114 or approaches setpoint actuator voltage 114, which could lead to the two short circuited injectors opening and injecting, first of all, the actual actuator voltage 144 or 146, ascertained at measuring time 128, is compared to an actuator voltage threshold value 112, and changes in the control current signal are carried out by the controller only if actual actuator voltage 144 or 146 is greater than actuator voltage threshold value 112.

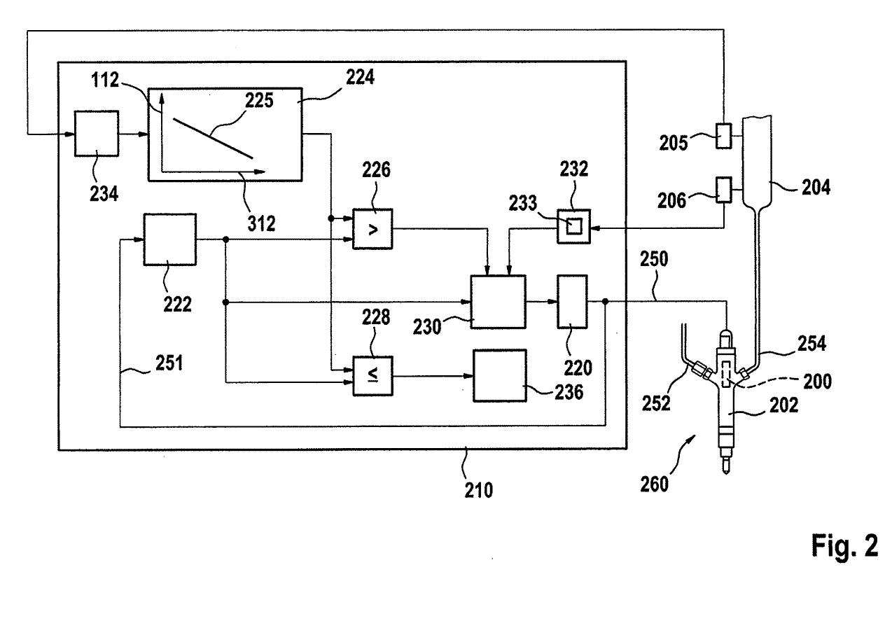

In a schematic block diagram, FIG. 2 shows a control device 210 for a fuel injection device 260 for injecting fuel into the combustion chambers of an internal combustion engine (not shown) of a motor vehicle. Fuel injection device 260 is represented, for instance, by a single fuel injector 202, which is connected to a fuel pressure accumulator 204 via a fuel supply line 254 and to a fuel tank (not shown) via a fuel return line 252. A piezoelectric actuator 200 included in fuel injector 202 is connected to a control unit 220 of control device 210 via an electric control line 250. During the operation of control device 210, control unit 220 is designed to control actuator 200, using a control current signal conducted via control line 250, in such a way that fuel injector 202 opens and carries out a fuel injection.

Within control device 210, a voltage measuring line 251 branches off from control line 250, via which the output of control unit 220 and actuator 200 are connected to a voltage meter 222 of control unit 210. Voltage meter 222 is designed, in the operation of control device 210, at a specifiable measuring time during a fuel injection performed by fuel injector 202, to ascertain an actual actuator voltage that is present at actuator 200 at the measuring time.

Furthermore, control device 210 has a setpoint actuator voltage sensor 232 that is connected to a fuel pressure sensor 206 situated on fuel pressure accumulator 204, and, based on a pressure ascertained by fuel pressure sensor 206 in fuel pressure accumulator 204, ascertains a setpoint actuator voltage at actuator 200 which is desired during a fuel injection at the measuring time, so as to be able to carry out the fuel injection in the desired manner. Setpoint actuator voltage sensor 232, in order to ascertain the setpoint actuator voltage, additionally takes into account characteristics variables 233 of fuel injector 202, which are stored, for instance, as shown, in setpoint actuator voltage sensor 232.

Control device 210 also has a control current controller 230 which is connected to voltage meter 222 and setpoint actuator voltage sensor 232 in such a way that, in the operation of control device 210, setpoint actuator voltage sensor 232 provides the setpoint actuator voltage to control current controller 230, and voltage meter 222 provides the actual actuator voltage value ascertained respectively during a fuel injection. Control current controller 230, which is also connected to control unit 220, is designed to modify the control current signal emitted by control unit 220, for a given fuel injection, in a regulating manner in such a way that the actual actuator voltage approaches the setpoint actuator voltage provided by setpoint actuator voltage sensor 232 during the additional fuel injection.

Voltage meter 222 is also connected to a first voltage comparator 226 and a second voltage comparator 228, to which, also during the operation of control device 210, it provides the actual actuator voltage value respectively ascertained during a fuel injection. Also connected to first voltage comparator 226 and second voltage comparator 228 is an actuator voltage threshold value sensor 224 of control device 210, which makes available an actuator voltage threshold value 112 to both first voltage comparator 226 and second voltage comparator 228 during the operation of control device 210. Actuator voltage threshold value sensor 224 has a characteristics curve 225 which describes the relationship between temperature 312 at actuator 200 and actuator voltage threshold value 112. For the ascertainment of temperature 312 at actuator 200, control device 210 has a temperature sensor 234 that is connected to actuator voltage threshold value sensor 224, which is designed to derive temperature 213 at actuator 200 from a temperature signal emitted by fuel temperature sensor 205 that is situated at fuel pressure sensor 206, for instance, by using the fuel temperature, in fuel pressure accumulator 204, unchanged as an approximate value, or by adding to it a constant assumed temperature difference. Temperature sensor 234 may alternatively, or in addition, also be connected to additional temperature sensors which, for example, measure a cooling water temperature of the internal combustion engine or measure the temperature of actuator 200 directly.

First voltage comparator 226 is developed to compare the actual actuator voltage value ascertained respectively during a fuel injection, in the operation of control device 210, to actuator voltage threshold value 112, and to emit a release signal if the actual actuator voltage value has a greater absolute value than the actuator voltage threshold value. At the output end, first voltage comparator 226 is connected to control current controller 230 in such a way that control current controller 230 is released or blocked if first voltage comparator 226 emits the release signal or the blocking signal.

Second voltage comparator 228 is developed also to compare the actual actuator voltage value ascertained respectively during a fuel injection, in the operation of control device 210, to actuator voltage threshold value 112, but to emit a fault signal if the actual actuator voltage value has a greater or a smaller absolute value than the actuator voltage threshold value. At its output end, voltage comparator 228 is connected to a fault treatment unit 236, of control device 210, which stores the number of incoming fault signals as diagnostic information during the operation of control device 210, and, if the occasion arises, in response to the exceeding of a specifiable fault number threshold, initiates a warning signal and/or an emergency shutdown, for instance, of respective fuel injector 202 or of the entire internal combustion engine.

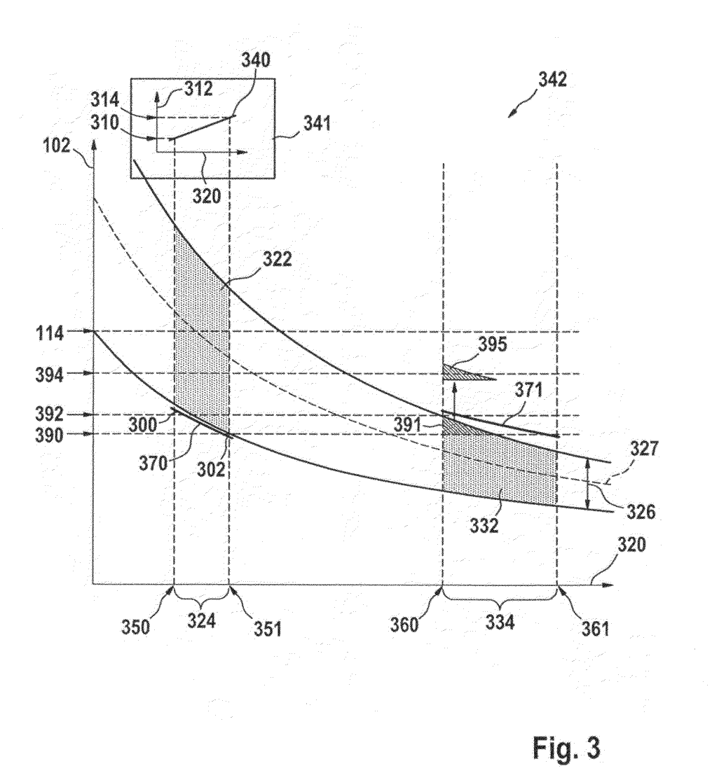

We shall now explain in greater detail particularly the functioning of actuator voltage threshold value sensor 224, with reference to FIG. 3 as an exemplary embodiment. Apart from tolerances based on manufacturing variance, the electrical capacitance of piezoelectric actuators has an additional response to temperature changes 340, that is, the capacitance of the actuators may be represented as the sum of a temperature-dependent part without specimen-dependent tolerances and an additional part that combines the specimen-dependent tolerances. At rising capacitance, the capacitance becomes greater in general. Response to temperature changes 340 of the actuator capacitance is shown in a frame-enclosed diagram 341 within FIG. 3.

The main diagram 342 of FIG. 3 is a state diagram of the relationship between electrical actuator capacitance 320 and the electrical voltage 102 present at actuator 200, the behavior of an ideal capacitor is basically given by

$$U = \frac{Q}{C} = \frac{1}{C} \int I ( t ) d t ,$$

in a simplified manner, where t stands for time, I(t) for the current curve over time during the charging current pulse, Q for the electrical charge put into the actuator by the charging current curve, C for actuator capacitance 320 and U for electrical voltage 102 that is present in actuator 200.

Now, in main diagram 342 of FIG. 3, a first two-dimensional area 322, marked in a planar manner, represents the combined tolerances of control device 210 and of actuator 200, which are guaranteed according to their specifications. In this instance, a proportion 324 of the tolerances, which refers back to the influence of the response to temperature changes 340 of the capacitance of actuator 200, in the interval between a minimum operating temperature 310 and a maximum operating temperature 314, was split off from the remaining proportion 326 of the combined tolerances and is shown along capacitance axis 320 of the diagram. Lower boundary 350 and upper boundary 351 of this proportion 324 correspond to minimum operating temperature 310 and maximum operating temperature 314, respectively. The remaining part 326 of the combined tolerances is shown along voltage axis 102, as interval 326 on both sides of a nominal voltage curve 327, in which tolerances are not taken into account (with the exception of response to temperature changes 340).

A second two-dimensional tolerance range 332, also marked in a planar manner, analogously represents the combined tolerances of control device 10, of actuator 200 and of a similarly assumed additional actuator, which is connected in parallel to actuator 200. A proportion 334 of the tolerances is also analogous, which refers to the influence of response to temperature changes 340 of the doubled capacitance of the actuators connected in parallel, split off from the remaining part of tolerances 326, and shown along capacitance axis 320 of the diagram. The lower boundary 360 and the upper boundary 361 of this proportion 334 corresponds, in this context, to the minimum operating temperature 310 or maximum operating temperature 314, having, compared to boundaries 350 and 351 of first two-dimensional tolerance range 322, respectively doubled capacitance values.

Now, in the operation of control device 210, actuator voltage threshold value sensor 224 first, with the aid of response to temperature changes 340, ascertains a capacitance value that is valid for actuator 200 at temperature 312 ascertained by temperature sensor 234. Subsequently, with the aid of an actuator voltage threshold value curve 370 shown in the main diagram of FIG. 3, a voltage value corresponding to the capacitance value is located as the actuator voltage threshold value.

Actuator voltage threshold value curve 370 is expediently selected, as shown, in such a way that it lies below first two-dimensional tolerance range 322, so that it is made possible, by control current controller 230, to line out all the tolerances corresponding to the specifications of control device 210 and actuator 200. In addition, it is expedient further to determine actuator voltage threshold value curve 370 in such a way that a curve 371, derived from it, which is created from actuator voltage threshold value curve 370 by the assumption of a doubled actuator capacitance, lies above second two-dimensional tolerance range 322, so that it is made possible reliably to detect a short circuit-conditioned doubling of the actuator capacitance for the entire tolerance range corresponding to the specifications of control device 210 and actuator 200.

To the extent of two-dimensional tolerance ranges 322, 332, shown in FIG. 3, this is only possible if actuator voltage threshold value curve 370 is determined as a function of capacitance or, ascertained by response to temperature changes 340, as a function of temperature. An actuator voltage threshold value 390, determined to be constant at the lower boundary of first two-dimensional tolerance range 322, would, for instance, lead to a short circuit no longer being correctly detected within approximately triangular region 391 that is shaded within second two-dimensional tolerance range 332. In this case, control current controller 230 would change the control current signal for subsequent fuel injections in such a way that, as indicated by an approximately triangular area 395 in FIG. 3, that is displaced over a functional boundary 394 of the actuators, a simultaneous opening of the actuators cannot be reliably prevented.

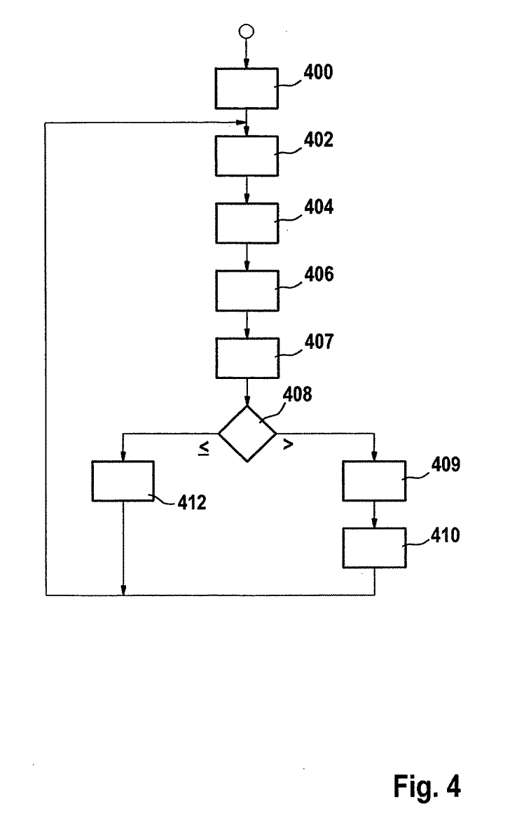

FIG. 4 shows a flow chart of a method for controlling a fuel injector for an internal combustion engine which has a piezoelectric actuator. The method shown is able to be performed, for instance, by using control device 210 as in FIG. 2.

In step 400, the actuator of the fuel injector has applied to it a control current signal for the execution of a fuel injection, for instance, during a first working cycle of the internal combustion engine. The control current signal includes, for instance, a charging current pulse by which the fuel injector is opened during orderly operation, and an oppositely directed discharge current pulse, by which the fuel injector is closed again.

In step 402, during the fuel injection, at a specifiable measuring time, the voltage present at the actuator is measured, in order to obtain an actual actuator voltage as a voltage value, in this manner. “During the fuel injection” means the entire time span of the control current signal, during which the fuel injection takes place during orderly operation, that is, from the beginning of the charging current pulse to the end of the discharge current pulse. The measuring time may be set, for example, shortly before the beginning of the discharge current pulse.

In step 404, a temperature at actuator 200 is determined. This may be done approximately, for instance, by estimating the temperature based on the fuel supply temperature and/or the cooling water temperature. In step 406, the electrical capacitance is calculated from the temperature which the actuator has at the respective temperature, for example, while using individual characteristics curves of the controlled actuator specimen. In step 407, an actuator voltage threshold value is ascertained from the capacitance. The actuator voltage threshold value is ascertained, for instance, in such a way that it amounts to only slightly more than the amount of the actual actuator voltage, which is to be expected, at most, when taking into account control device tolerances and actuator tolerances, based on manufacturing variances and possibly the influence of the temperature of the control device, for the case that the actuator has the ascertained temperature and is connected in parallel to an additional actuator. Steps 406 and 407 may also be carried out in combined fashion, for instance, by using a characteristics curve that may be specimen-specific, which links the temperature to the actuator voltage threshold value.

In decision step 408 it is compared whether the actual actuator voltage ascertained in step 402 is greater than the actuator voltage threshold value. If this is the case, the method assumes that no interference case is present having a short circuit of several actuators, and branches to step 409. At this point, a setpoint actuator voltage is ascertained which is desired for a subsequent fuel injection at a measuring time at which the actual actuator voltage is ascertained, with respect to the fuel injection present in step 402. A constant specified value (possibly while using individual characteristics values of the fuel injector) is used as the setpoint actuator voltage, for example, or the setpoint actuator voltage is ascertained based on the pressure in the fuel supply. In step 410, a control current signal is ascertained for an additional fuel injection, for instance, as the next injection of the same type provided by the fuel injector, using the setpoint actuator voltage as the control target. Thereafter, the method jumps back to step 400, where the control signal, ascertained in step 410, that was possibly modified with respect to the present fuel injection so as to carry out the additional fuel injection, is emitted to the injector.

However, if it is determined in decision step 408, for the present fuel injection, that the actual actuator voltage ascertained in step 402, is below the actuator voltage threshold value, then in step 412 a fault signal is emitted and, as the case may be, is processed further for diagnostics, warning purposes or other purposes. In that case, the method jumps back to step 400, without a new control current signal having been ascertained in step 410, so that in step 400, a control current signal, that is unchanged with respect to the present fuel injection, is emitted to the actuator for a further fuel injection.

What is claimed is:

1. A method for controlling a fuel injector for an internal combustion engine, which has a piezoelectric actuator, the method comprising:
controlling the actuator using a control current signal for a fuel injection;
ascertaining an actual actuator voltage during the fuel injection;
comparing whether the actual actuator voltage is greater than an actuator voltage threshold value; and
controlling the control current signal, if the actual actuator voltage is greater than the actuator voltage threshold value, for an additional fuel injection, so that the actual actuator voltage approaches a setpoint actuator voltage during the additional fuel injection.

2. The method as recited in claim 1, further comprising:
ascertaining a temperature at the actuator; and
ascertaining the actuator voltage threshold value based on the temperature.

3. The method as recited in claim 2, wherein the ascertaining of the temperature at the actuator takes place based on at least one of a fuel temperature and a cooling water temperature of the internal combustion engine.

4. The method as recited in claim 2, wherein the ascertaining of the actuator voltage threshold value further takes place based on at least one characteristics value of the fuel injector.

5. The method as recited in claim 2, wherein the ascertaining of the actuator voltage threshold value includes a linear interpolation between a first supporting value and a second supporting value, the first supporting value and the second supporting value corresponding to a minimum operating temperature of the actuator and a maximum operating temperature of the actuator.

6. The method as recited in claim 1, further comprising:
ascertaining the setpoint actuator voltage based on at least one of a pressure in a fuel pressure accumulator of the internal combustion engine and at least one characteristics variable of the fuel injector.

7. The method as recited in claim 1, further comprising:
emitting a fault signal if the actual actuator voltage is not greater than the actuator voltage threshold value.

8. A storage device storing a computer program having program instructions, which are stored on a machine-readable carrier, the program instructions, when executed by a control device, causing the control device to perform the steps of:
controlling a piezoelectric actuator of a fuel injector of an internal combustion engine using a control current signal for a fuel injection;
ascertaining an actual actuator voltage during the fuel injection;
comparing whether the actual actuator voltage is greater than an actuator voltage threshold value; and
controlling the control current signal, if the actual actuator voltage is greater than the actuator voltage threshold value, for an additional fuel injection, so that the actual actuator voltage approaches a setpoint actuator voltage during the additional fuel injection.

9. A control device for controlling a fuel injector for an internal combustion engine, which has a piezoelectric actuator, comprising:
a control unit which controls the actuator using a control current signal for a fuel injection;
a voltage meter which ascertains an actual actuator voltage during the fuel injection;
a voltage comparator which compares whether the actual actuator voltage is greater than an actuator voltage threshold value; and
a control current controller which, if the actual actuator voltage is greater than the actuator voltage threshold value, controls the control current signal for an additional fuel injection, so that the actual actuator voltage approaches a setpoint actuator voltage during the additional fuel injection.

10. The control device as recited in claim 9, further comprising:
a temperature sensor which ascertains a temperature at the actuator; and
an actuator voltage threshold value sensor which ascertains the actuator voltage threshold value based on the temperature.
